(19) United States
(12) Patent Application Publication
(10) Pub. No.: US 2007/0262142 A1
(43) Pub. Date: Nov. 15, 2007

(54) System and method for processor-based inventory data collection and validation with internal integrated scanner

(75) Inventors: David Whitehouse, Toronto (CA); Robert Baranowski, San Diego, CA (US); Robert Jude Melucci, San Diego, CA (US); Thomas Harrison Lupfer, San Diego, CA (US)

Correspondence Address: GARDERE WYNNE SEWELL LLP;INTELLECTUAL PROPERTY SECTION, 3000 THANKSGIVING TOWER, 1601 ELM ST, DALLAS, TX, 75201-4761, US

(73) Assignee: WIS International, Mississauga (CA)

(21) Appl. No.: 11/434,328

(22) Filed: May 15, 2006

(51) Int. Cl. G06Q 30/00; G06Q 20/00

(52) U.S. Cl. 235/385; 705/22

(57) ABSTRACT

A system and method for collecting and validating inventory data is disclosed. In one embodiment, a processor-based inventory data collection system, with an internal integrated scanner, for efficiently collecting and validating inventory data includes a central processor coupled to a memory bus. The internal integrated scanner allows an operator to use one hand to scan and count merchandise, leaving the other hand free to adjust and move merchandise as needed. Since the operator can use the system to scan and count merchandise with only one hand, the operator is able to efficiently take the inventory without frequently pausing to adjust or move the merchandise. The central processor is adapted to receive the inventory data and is operable to validate the inventory data using a plurality of program codes. At least one flash memory device is coupled to the memory bus. The flash memory is adapted to store inventory data as the data is entered into the device and also adapted to store the program codes. The invention includes at least one random access memory device coupled to the memory bus. The random access memory is adapted to store validation tables and validated inventory data. The invention includes keyboards and an integrated scanner for entering the inventory data into the computer. The invention includes a display operable to show a report of the inventory data collection and to provide other operator feedback.

### TECHNICAL FIELD

This invention relates to processor-based data collection systems and methods and, more particularly, to a processor-based system with an internal integrated scanner and a method for collection, validation and consolidation of inventory data.

### BACKGROUND OF THE INVENTION

Accurate inventory information is vital to the success of many businesses engaged in the sales of goods and merchandise. A business, such as a retail store, must maintain a reasonably accurate inventory. This is essential to meeting the demands of its customers, and it increases the likelihood that the customer will return to shop. If the retail store is out of one or more items, customers seeking the item will be disappointed. A disappointed customer will most likely shop at another store, and the retail store will lose the customer's purchase. Furthermore, the retail store may lose the customer in the long-term because the customer may conclude that another well-stocked store can better meet their needs. On the other hand, an overstock of inventory results in a waste of capital.

When an item is sold, the inventory level of the item decreases. The retail store typically re-stocks the item before the inventory level becomes too low or the store completely runs out of the item. In order to be able to restock the item before the inventory level gets too low, the retail store must regularly monitor the inventory level. In fact, most retail stores monitor the inventory frequently to ensure they have sufficient products to meet the regular demands of their customers.

Typically, a retail store keeps its inventory information stored in a computerized system. This system will typically not detect errors in inventory levels due to customer or employee theft, shipping or receiving errors, and product mislabeling. In order to monitor the inventory accurately, an employee or some other individual must periodically physically count each item to validate the computerized inventory information. In large retail stores that stock thousands of items, it is difficult for a retailer to manually count the items and collect the inventory data. Special devices are often used.

Retail stores often contract with a service provider to collect and consolidate their inventory data. The service provider usually has operators that use specialized computers or other hand-held machines (“hand-held machines”) to collect the inventory data. Outside services are also used to provide an independent opinion of the inventory levels for financial reporting purposes.

Conventional computers and hand-held machines designed to collect inventory data do not facilitate efficient collection and validation of inventory data. Normal retail inventory counting requires an operator (i.e., counter) to physically adjust the merchandise to be counted so that all items can be seen, bar codes on the items are scanned and the items counted. Thus, the operator must use a hand to adjust the merchandise in order to see and count the merchandise.

Traditional inventory counting hand-held machines also require the operator to use both hands to operate the machine. These machines generally include a keyboard and a separate hand-held external scanner. One hand is needed to operate a keyboard while the other hand is needed to hold the scanner, leaving no hand to adjust the merchandise. Consequently, the operator must frequently pause, use one or both hands to adjust the merchandise and then return to counting and entering data. The operator is thus less efficient in counting the merchandise due to frequent interruptions.

Accordingly, there exists a need for hand-held machines that: allow efficient collection and validation of inventory data; provide efficient consolidation and reporting of inventory data; and quickly perform complex inventory data manipulation, validation and consolidation. There exists a need for hand-held machines that allow the operator to efficiently count the merchandise without frequent interruptions to adjust the merchandise. There also exists a need for hand-held machines that provide protection against power failure and provide efficient transfer of inventory data to external devices.

### SUMMARY OF THE INVENTION

A system for collecting and validating inventory data includes an integrated scanner. The integrated scanner is coupled to the central processor of the system, and is adapted to transfer the inventory data to the central processor from the integrated scanner. An important aspect of the system is that only one hand is required to operate the machine, leaving the other hand free to adjust the merchandise. Thus, an operator can efficiently collect inventory data without the frequent interruptions required to adjust and move the merchandise. The system is designed to allow the operator to easily scan bar codes utilizing an integrated internal scanner and also to enter inventory data via two keyboards. The bar codes are machine readable identifiers of a particular product or item. The system includes a display to show the inventory data collected.

In one embodiment, a processor-based inventory data collection system with an integrated scanner for efficiently collecting and validating inventory data includes a central processor coupled to a memory bus. The central processor is adapted to receive the inventory data and operable to validate the inventory data using a plurality of program code. Flash memory is coupled to the memory bus. The flash memory is adapted to store inventory data, as the data is entered into the device, and also adapted to store the program code. A random access memory is also coupled to the memory bus. The random access memory is adapted to store validation tables and program code. The validation tables are used by the central processor to validate the inventory data.

### BRIEF DESCRIPTION OF THE DRAWINGS

FIG. 1 is a simplified, high-level block diagram of an inventory data collection system.

FIG. 2 is a detailed block diagram of a data collection system in accordance with one embodiment of the invention.

FIG. 3 is a flow diagram of a typical inventory data collection process in accordance with one embodiment of the invention.

FIG. 4 shows an example error message displayed by the data collection system when an entry fails to meet a restrictive criteria.

FIG. 5 shows an example error message wherein the entered number is not in the inventory master file.

FIG. 6 shows an example of a successful entry

FIG. 7 shows results of an inventory audit displayed on a hand-held machine.

FIG. 8 shows a hand-held inventory data collector in accordance with one embodiment of the invention.

### DETAILED DESCRIPTION OF PREFERRED EMBODIMENTS

The various features and methods of the inventory data collection system will now be described in the context of inventory data collection. Those skilled in the art will recognize that the system is applicable to other types of data collection as well.

Throughout the description of the embodiments, implementation-specific details will be given on how the inventory data collection system is used to efficiently collect inventory data. These details are provided to illustrate the preferred embodiments of the invention and not to limit the scope of the invention. The scope of the invention is set in the claims section.

The inventory data collection system provides a solution to the previously discussed problems. In one aspect, the system allows a business or an individual to efficiently maintain accurate inventory information.

The inventory data is typically collected in a retail establishment or a warehouse where a physical inventory of merchandise is to be taken. The merchandise is typically stored on shelves or stacked in another manner. The inventory data collection system allows an operator to efficiently take a physical count of the merchandise. The operator may be an employee of the retail establishment or may be employed by an entity that specializes in taking physical inventories for retail establishments and other businesses. The operator may collect the inventory data as part of an audit of the inventory, or as part of a routine verification of the physical inventory levels.

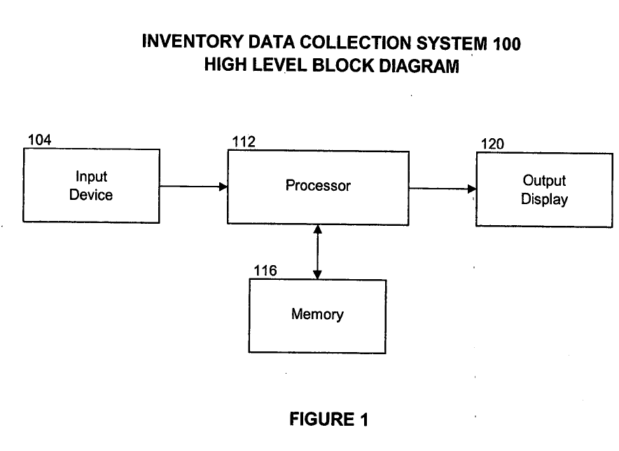

FIG. 1 is a simplified, high-level block diagram of the inventory data collection system 100. The data collection system 100 includes an input device 104 coupled to a processor 112. The input device 104 may be an internal keyboard or an integrated scanner. The integrated internal scanner can be a laser scanner or any other type of scanner. An operator can enter inventory data into the data collection system 100 through the input device 104.

The central processor 112 can access the inventory data entered into the system 100. The central processor 112 performs various operations on the inventory data such as validating the data and performing various computations.

An output device 120 is coupled to the processor 112. In one embodiment, the output device is a graphical liquid crystal display (LCD), which is incorporated into the data collection system 100, and is used to display results of an inventory audit or to display error messages.

A memory 116 is used to store the program code that runs the data collection system 100 as well as to store inventory data. The central processor 112 accesses the program code and the inventory data in the memory 116.

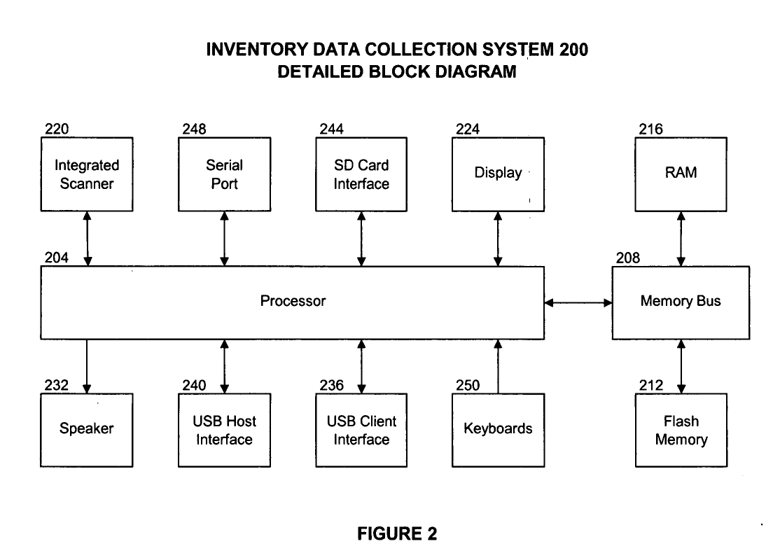

FIG. 2 is a detailed block diagram of one embodiment of the inventory data collection system 200. The data collection system 200 includes a central processor 204 coupled to a memory bus 208. In one embodiment, a low-power processor (e.g., Intel PXA 270) is used as the central processor 204. The central processor 204 is a high-speed microprocessor that enables the system 200 to quickly perform complex data manipulations. During inventory data collection, the operator can scan in inventory data using the integrated internal scanner at a high rate. The inventory data is validated against known parameters using sophisticated validation logic. The central processor 204 enables fast counting at a high scan rate and executes validation logic to ensure accurate data.

The central processor 204 is used to execute program code, and to interface with and control peripheral equipment (e.g., scanner, keyboards, display, serial port, Secure Digital card port, Universal Serial Bus ports and speaker). The program code is an application program developed specifically for inventory counting. The memory bus 208 is used to communicate with memory. The operation of these components will be described later.

One or more flash memory device 212 is coupled to the memory bus 208, and is used to store one or more programs as well as the inventory data. In one embodiment, the flash memory 212 stores program code for the central processor 204 and the inventory data. The program code includes the code for validation logic and other code for carrying out computations during the inventory data collection process. As inventory data is entered into the system 200, the data is written into the flash memory. The flash memory 212 is non-volatile, and therefore can retain information even when power is removed from the data collection system 200. The program code for the central processor 204 is also stored in the flash memory 212 so that a user need not reload the program code if the system 200 loses power. For example, the system may lose power in the event of a battery malfunction. The inventory data is stored in the flash memory 212 to protect the data from battery, software or hardware malfunction.

One or more random access memory (RAM) device 216 is coupled to the memory bus 208. In one embodiment, Synchronous Dynamic Random Access Memory (SDRAM) is used for RAM. The RAM 216 is used to execute the program code and store values that change frequently or require high-speed access.

The RAM 216 includes one or more accumulators. As will be described further, after the inventory data is validated, the data is summarized in the accumulators. The stored data is used to track and audit the entered information. The RAM 216 also stores validation tables, which are used to validate the inventory data. By storing the validation tables in SDRAM, power consumption is reduced, because the RAM 216 uses less power than the flash memory, thus extending the battery life of the data collection system 200.

Additional memory can be added to the system 200 through an externally accessible Secure Digital (SD) card connector or an externally accessible Universal Serial Bus (USB) connector.

An integrated internal scanner 220 is coupled to the central processor 204. The integrated scanner 220 can be a laser scanner or any other type of scanner. The inventory data can be entered into the system 200 by the scanner 220. The scanner 220 scans inventory data in the form of bar codes, which are then decoded into serial data and relayed to the central processor 204. The scanner 220 is mechanically integrated into the system 200. Thus, the operator is not required to use a hand to hold the scanner 220. The system 200 is designed so that the operator can use one hand to scan and operate the system (i.e., count merchandise), leaving the other hand free to adjust the merchandise. Since the operator is no longer required to stop the scanning and counting process in order to adjust the merchandise, a more efficient counting process is provided.

One or more keyboards 250 are coupled to the processor 204. The inventory data may be entered into the data collection system 200 from the keyboards 250. In one embodiment, the keyboard incorporates circuitry to eliminate a phantom key condition that occurs in standard key switch matrix arrangements. A phantom key condition occurs when three of four keys in the corners of a square are pressed simultaneously. By eliminating the phantom key condition, high-speed data entry by the operator is facilitated. In one embodiment, the keyboards include custom keys that are labeled specifically for the inventory data collection process. In one embodiment, the most commonly used numeric keys are made larger to facilitate their efficient use.

The data collection system 200 includes a display 224 coupled to the processor 204. The display is used to present information such a confirmation of the collected data or the results of an inventory audit. In one embodiment, a graphical liquid crystal display (LCD) is used. The LCD's size permits the display of a large amount of information, which is useful to the operator. In one embodiment, the font size of the LCD can be adjusted to display more information with a smaller font or less information with a larger font.

The data collection system 200 includes an audio output speaker 232 coupled to the processor 204. The audio output speaker 232 can be used to sound an error tone to gain the attention of the operator.

In one embodiment, a USB client interface 236 and a USB host interface 240 are coupled to the processor 204. These interfaces provide communication capability with other external devices such as other data collection systems, printers, personal computers, personal data assistants (PDAs), storage systems, or memory devices. External USB memory devices attached to the USB host interface 240 are used to transfer inventory data, program code, and inventory master files to or from the data collection system 200.

In one embodiment, a SD card interface 244 is incorporated into the inventory data collection device 200. The SD card interface can be used to attach wireless communication devices, RFID readers, additional storage, wide-area network (WAN) interfaces, or local area network (LAN) interface devices. It can also be used to update the program code or operating system for the data collection system 200.

In one embodiment, a serial port 248 is incorporated into the inventory data collection device 200. The serial port can be used to attach to external serial devices or collect software or hardware debug information for system development and debugging purposes.

In one embodiment, the stored data in the inventory data collection device 200 is transmitted to a central computer for permanent storage or additional processing. The stored data can be transmitted over the Internet or any other communication link, including wireless communication links. The central computer can be maintained by an entity engaged in collecting inventory data for retail businesses. The central computer can also be maintained by the retail business itself.

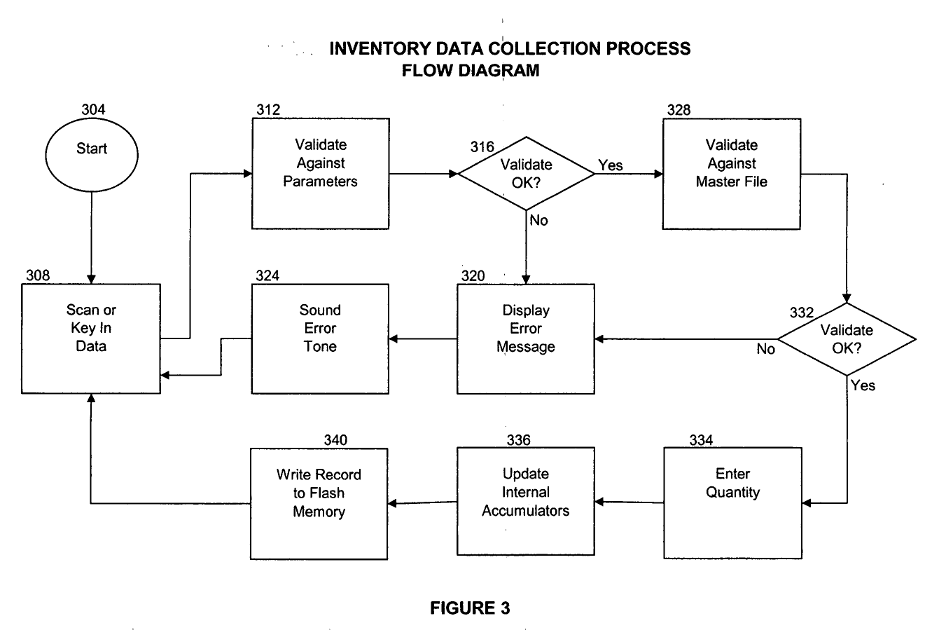

FIG. 3 is a flow diagram of an inventory data collection process in accordance with one embodiment of the invention. The process starts in step 304 and moves to step 308 where the inventory data is scanned or keyed in. The inventory data can be entered into the system from the keyboards or the integrated scanner 220 shown in FIG. 2. The inventory data can also be captured utilizing an external device such as an RFID reader plugged into the SD card interface, the USB host interface, the USB client interface, or an internal interface connector.

In one embodiment, the inventory data collection process includes capturing location information, a stock keeping unit (SKU) number, an item quantity, and a price. The location information may include a section, area, or other identifier that identifies the location of the subject inventory. The SKU number, which is usually represented by a bar code, is used to uniquely identify an inventory item, and is preferably captured via the internal scanner. The item quantity is either assumed to be a single unit or is entered via the keyboard. The item quantity can also be calculated via a built-in calculator by entering the quantity width, depth, and height of a product as it is stacked on a shelf. The following is an example of a typical internally stored record. This information is compressed to save storage space.

| SECTION | AREA | SKU | PRICE | QTY |
|---|---|---|---|---|
| 2110 | 55 | 546871 | 00754 | 00079 |

Other information such as breakdown, department, or class can also be stored. The information also can be entered, scanned, or extracted from an internally stored item master file.

Next, the process moves to step 312 where the captured data is validated against a set of parameters. In one embodiment, the data is validated against a set of restrictive parameters that is designed to reduce the likelihood of invalid or incomplete information. The restrictive parameters can include minimum and maximum restrictions on field lengths and entered values. The restrictive parameters can also include check digit validation calculations. For example, an entered SKU number can be restricted to only six digits or a specific number range. If the entered value contains a check digit, the device can calculate the correct check digit and compare that against the entered one. A check digit is a calculated value embedded in a SKU number and is used to reduce keying errors. The check digit is usually the last digit of the number and is calculated using an algorithm based on the other digits in the number. The check digit can provide a fast first pass validation without the need to perform a look-up in a master file. If the entered check digit does not match the calculated one, the record can be rejected.

The system can scan any common bar code symbology. Scanned entries can be restricted to specific bar code symbologies for different fields. For example, the system can restrict a section tag to 3 of 9 bar code symbols, an item scan to a Universal Product Code (UPC) or interleaved 2 of 5 bar code, and shelf label tags to Code 128 bar codes. A section tag is an identifying tag indicating what section of a store, stockroom, or warehouse the merchandise is located in, and can have a bar code or other identifying value. The section tag can be used to locate the counted merchandise, compare the count with a previous count for that section, or compare the count with a current summary value from an automated inventory system. A shelf label tag is a retailer-installed tag typically placed on the store shelf under the merchandise. It can include a bar code or a SKU number. The shelf label tag often has a price and a description of the item.

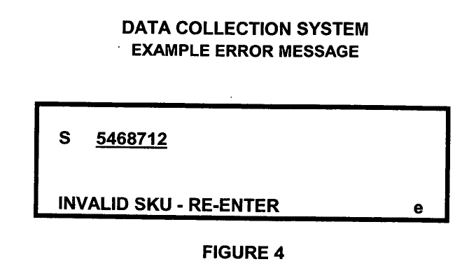

Next, the process moves to step 316 where it is determined whether the captured data can be successfully validated against the set of restrictive parameters. If the captured data is not successfully validated, an error message is displayed in step 320. The error message informs the operator about a problem with the captured data and provides information on how to resolve the problem. FIG. 4 shows an example error message. In FIG. 4, the operator entered in a SKU number of 5468712, one digit too many. Consequently, the entry was rejected and the operator was prompted to re-enter.

In one embodiment, an optional error tone may be sounded in step 324. The error tone is sounded to gain the attention of the operator. Alternatively, an error tone alone is sounded without an associated error message, to allow the operator to focus on the merchandise to be counted and not on the display. The process then again returns to step 308.

If the captured data has been successfully validated against a set of restrictive parameters, the process moves to step 328. In step 328, the captured data is validated against a master file. In one embodiment, the captured data is validated against an inventory item master file, which usually contains a list of valid SKU numbers. The master file may contain information that can be used to validate other data such as price or quantity on hand. The master file may also be used to provide information to generate inventory reports. A master file may contain many thousands of records. An example record in a master file is shown below:

| | ITEM- | | | |
|---|---|---|---|---|
| UPC-CODE | DESCRIPTION | SKU | PRICE | QUANTITY |
| 071142012349 | BOTTLED | 546871 | 00754 | 00079. |
| | WATER 24 | | | |
| | OZ SPORTS | | | |
| | PACK | | | |

In the above example, the UPC field provides the Universal Product Code, which is commonly used to uniquely identify an item. The description field can include the generic name of the item. In addition, the description field can also provide item identification feedback to the operator, or can be used to generate a report. The SKU field includes the stock keeping unit number that can be used as an alternative item identifier. The price field can be used to prompt the operator for additional information on certain price points. The quantity field can be used as a reasonableness check against the quantity observed. Other information such as department, class, or section can also be included in the master file.

In step 332 it is determined whether the captured data has been successfully validated against the master file. If the captured data is not successfully validated, the process branches to step 320 where an error message is displayed. As described above, if the validation fails, an error tone may be sounded in step 324 and the process flow returned to step 308.

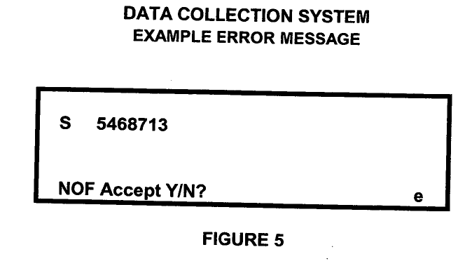

In one embodiment, the operator has the option to accept the rejected entry. FIG. 5 shows an example error message when the entered SKU is not on file (“NOF”) in the item master file. As shown in FIG. 5, in the error message, the operator is asked if the SKU number should be accepted anyway. The operator responds to the displayed question by pressing the YES or NO key on the system keypad.

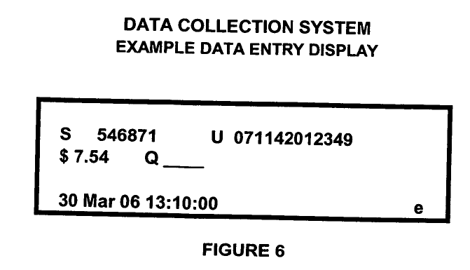

If the captured data is successfully validated against the master file or the operator has accepted a Not on File SKU, the process next moves to step 334 where the operator is prompted to enter the count quantity (shown in FIG. 6).

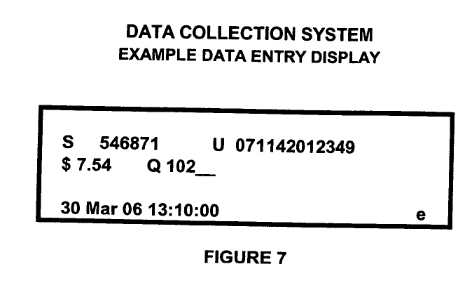

FIG. 7 shows results of an inventory audit displayed on the terminal. In the example, the SKU field indicates an SKU number of 546871 was keyed in or scanned in by the operator, passed all validation and the operator entered a quantity of 102.

In step 336, internal accumulators are updated. In step 340, the data is stored in flash memory to preserve it and prevent it from being lost due to an unexpected malfunction such as a power loss. The process next returns to step 308 where the process begins again.

The validated data can be consolidated in a personal computer or a central computer. In one embodiment, the central computer can receive inventory data from a plurality of hand-held, data collection computers (i.e., hand-held machines). The data can be again validated, consolidated in a variety of reports and transferred to the central computer that maintains the inventory data. The operator can transfer the validated data or results of an inventory audit over the Internet or other communication link. In one embodiment, the operator connects the hand-held computer to the Internet, and transmits the results of the inventory audit to the central computer. Thus, the central computer can store inventory data originating from many retail establishments or warehouses. Consider, for example, a scenario where a retail chain establishment operates hundreds of stores in different locations. The present invention can be used to collect and validate inventory data from the stores in different locations, and the data can be consolidated in the central computer.

The described process can be modified and enhanced as required for a specific inventory or other data collection task. For example, tasks such as section changes, editing functions, the downloading of software or configuration information, the manual configuration of the terminal, the transferring of data to another device such as a central computer or another hand-held computer, report generation, and hardware diagnostics can be implemented.

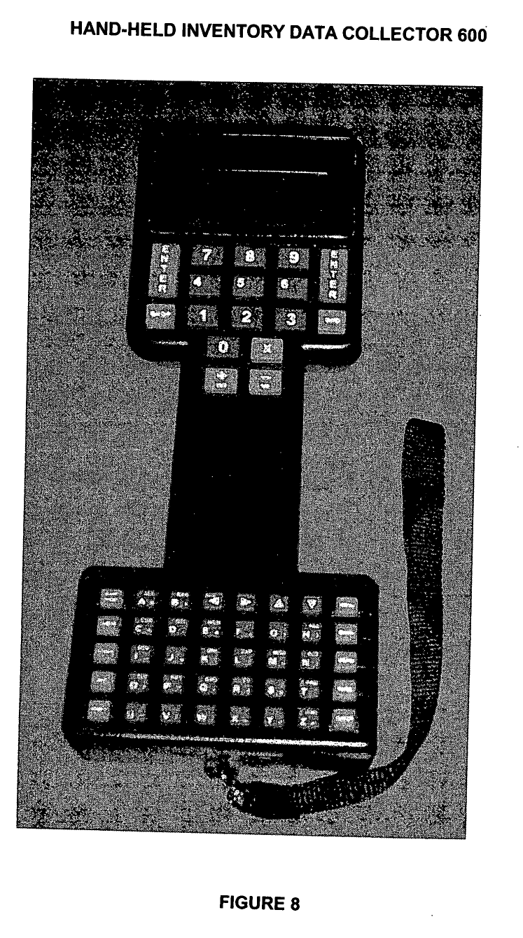

FIG. 8 shows a hand-held inventory data collector 700 in accordance with one embodiment of the invention. The data collector 700 includes an internal integrated scanner, which allows the operator to scan and count inventory with only one hand. The inventory data collector 700 includes a rectangular top and bottom section connected to each other through an elongated middle section. The top section is designed to house the internal integrated scanner, a keyboard, a display and other electronics and software. The bottom section is designed to house a second keyboard, electronics and software. The operator grasps the elongated middle section with one hand to scan the merchandise data. The scanner is activated by pressing a trigger switch with the index finger of the same hand. The numeric entry keys are activated using the thumb of this hand. In one embodiment, a first and a second ENTER key are placed on the keyboard at predetermined locations to allow either a right-handed operator or a left-handed operator to conveniently operate the machine. The operator can use the other hand to adjust and move merchandise when necessary. The construction of the inventory data collector 600 allows the operator to hold and easily maneuver the data collector to point the integrated scanner to the merchandise in order to scan the merchandise. The data collector utilizes the system 200 shown in FIG. 2 and the process of FIG. 3. The data collector 700 is designed to optimize data collection speed, survive rough physical treatment, and minimize battery consumption. It is designed to provide a cost-effective solution to inventory data collection.

The data collector utilizes ultra-capacitors, which allow it to continue to operate during power interruptions due to battery power loss. A battery power loss may occur if the data collector is accidentally dropped by the operator and the batteries pop out. The data collector includes flash memory and SDRAM. As inventory data is entered into the data collector, the data is written into the flash memory, thus providing a high degree of safety. When the data collector placed in a sleep mode, the SDRAM goes into a self-refresh mode. During the self-refresh mode, the total current consumption by the data collector is quite low. The data collector uses a set of batteries, which maintain the SDRAM data for several weeks. In addition, the ultra-capacitors maintain the SDRAM data for several minutes during battery changes or accidental power interruptions. The data collector utilizes transient voltage suppression (TVS) diodes on external connections to minimize adverse effects of electrostatic discharge (ESD). Surface mount technology (SMT) is utilized for cost containment purposes as well as improved resilience to vibrations and mechanical shocks.

From the foregoing it will be appreciated that, although specific embodiments of the invention have been described herein for purposes of illustration, various modifications may be made without deviating from the spirit and scope of the invention. Accordingly, the invention is not limited except as by the appended claims.

What is claimed is:

1. A processor-based inventory data collection system for efficiently collecting and validating inventory data, comprising:
a central processor coupled to a memory bus, the central processor adapted to receive the inventory data and operable to validate the inventory data using a plurality of program codes;
at least one flash memory device coupled to the memory bus, the flash memory adapted to store inventory data as the data is entered into the device and also adapted to store the program code;
at least one random access memory device coupled to the memory bus, the random access memory adapted to store validation tables and validated inventory data, the validation tables used by the central processor to validate the inventory data;
an internal integrated scanner coupled to the central processor and adapted to transfer the inventory data to the central processor;
one or more keyboards for entering the inventory data into the computer;
a display operable to show a report of the inventory data collection;

2. The inventory data collection system of claim 1 wherein the flash memory stores program codes for validation logic for validating the inventory data.

3. The inventory data collection system of claim 1 wherein the flash memory is a non-volatile memory capable of retaining stored data when power is removed from the system.

4. The inventory data collection system of claim 1 wherein the external connections are electrostatic discharge protected.

5. The inventory data collection system of claim 1 further comprising a speaker coupled to the system.

6. The inventory data collection system of claim 1 further comprising USB and SD card connectors adapted to couple additional external devices to the system.

7. An inventory data collection and validation system, comprising:
a central processor coupled to a memory bus, the central processor adapted to receive inventory data and operable to validate the inventory data using a plurality of program codes;
at least one memory module coupled to the memory bus, the memory module adapted to store inventory data as the data is entered into the device and also adapted to store the program codes;
an internal integrated scanner coupled to the central processor and operable to scan in inventory data and to transfer the inventory data to the central processor;
one or more keyboards, coupled to the processor, for entering the inventory data into the system;
a display operable to show operator feedback or a report of the inventory data collection;

8. The inventory data collection system of claim 7 further comprising flash memory adapted to store program codes for validation logic and for validating the inventory data.

9. The inventory data collection system of claim 8 wherein the flash memory is non-volatile memory capable of retaining stored data when power is removed from the system.

10. The inventory data collection system of claim 7 further comprising at least one random access memory device coupled to the memory bus, the random access memory adapted to store validation tables and validated inventory data, the validation tables used by the central processor to validate the inventory data.

11. The inventory data collection system of claim 7 further comprising an integrated scanner coupled to the central processor.

12. A method of collecting and validating inventory data using a hand-held inventory data collection computer with an internal integrated scanner, comprising:
entering the inventory data using the integrated scanner into the computer;
validating the entered data against a set of restrictive parameters, the parameters designed to reduce the likelihood of invalid inventory data;
validating the entered data against a master file, the master file including a list of valid SKU numbers;
displaying an error message if the entered data is not successfully validated against the restrictive parameter and the master file;
storing the validated data in at least one random access memory device and in at least one flash memory device;
displaying a report of the inventory in a graphical display.

13. The method of claim 12 wherein the inventory data is entered into the computer by a keyboard.

14. The method of claim 12 further comprising:
entering location information of a merchandise;
entering the SKU number of the merchandise, the SKU number identifying the merchandise;
entering the price of the merchandise.

15. The method of claim 12 wherein the restrictive parameters include minimum and maximum restrictions on field lengths and entered values.

16. The method of claim 12 further comprising sounding an error tone if the inventory data is not successfully validated against the set of restrictive parameters and the master file.

19. The method of claim 12 further comprising storing validation tables in the random access memory, the validation tables used to validate the inventory data.

20. A method of collecting and validating inventory data by an operator using a portable computer with an internal integrated scanner, comprising:
scanning bar codes using the integrated scanner from merchandise to retrieve the inventory data;
validating the inventory data against a set of restrictive parameters, the parameters designed to reduce the likelihood of invalid inventory data;
validating the inventory data against a master file, the master file including a list of valid SKU numbers;
displaying an error message if the inventory data is not successfully validated against the restrictive parameter and the master file;
storing the validated data in a random access memory and in a flash memory device;
displaying a report of the inventory in a graphical display.

21. The method of claim 20 further comprising:
entering location information of merchandise into the computer;
entering the SKU number of the merchandise into the computer, the SKU number identifying the merchandise;
entering the price of the merchandise into the computer.

22. The method of claim 20 wherein the restrictive parameters include minimum and maximum restrictions on field lengths and entered values.

23. A processor-based inventory data collection device for efficiently collecting and validating inventory data, the device comprising a housing having a rectangular top and a bottom section connected by a grasping section, the grasping section being configured to allow an operator to grasp the device by one hand to scan and count inventory, the device comprising:
a central processor coupled to a memory bus, the central processor adapted to receive the inventory data and operable to validate the inventory data using a plurality of program codes;
at least one flash memory device coupled to the memory bus, the flash memory adapted to store inventory data as the data is entered into the device and also adapted to store the program code;
at least one random access memory device coupled to the memory bus, the random access memory adapted to store validation tables and validated inventory data, the validation tables used by the central processor to validate the inventory data;
an internal integrated scanner coupled to the central processor and adapted to transfer the inventory data to the central processor;
one or more keyboards for entering the inventory data into the computer;
a display operable to show a report of the inventory data collection.

24. The processor-based inventory data collection device of claim 24, wherein the top section includes the internal integrated scanner, a first keyboard, and the display.

25. The processor-based inventory data collection device of claim 24, wherein the bottom section includes a second keyboard.

26. The processor-based inventory data collection device of claim 24, wherein the grasping section is substantially elongated and is configured to allow the operator to grasp and maneuver the device during use.
